(19) United States
(12) Patent Application Publication
(10) Pub. No.: US 2010/0283347 A1
(43) Pub. Date: Nov. 11, 2010

(54) NOVEL GANGED ALTERNATING CURRENT GENERATOR

(76) Inventor: Clynton Caines, Suffolk, VA (US)

Correspondence Address: DUNCAN G. BYERS PC, 142 W. York Street, Suite 910, NORFOLK, VA, 23510, US

(21) Appl. No.: 12/534,624

(22) Filed: Aug. 3, 2009

Related U.S. Application Data
(60) Provisional application No. 61/176,407, filed on May 7, 2009.

(51) Int. Cl. H02K 21/24

(52) U.S. Cl. 310/156.36

(57) ABSTRACT

A ‘ganged’ electrical generator with mechanical input into a rotor shaft that is used to produce alternating current (AC), the generator employing commonly used components arranged in a novel design to produce magnetic flux-induced current in copper or other conducting windings. The electrical generator is comprised, in part, of two or more rotors paralleling a vented stator and wherein the rotors contain fixed permanent magnets that, when rotated on the shaft of the generator, produce a magnetic field that induces a current in the windings and the permanent magnets are oriented in a manner incorporating features of a unipolar magnet so as to render the full magnetic field available to induce current which travels through the windings of the stator. The stators and rotors are constructed of modular portions for easy replacement and repair of faulty parts.

This application claims the benefit of provisional patent application No. 61/176,407 filed on May 7, 2009.

### FIELD OF THE INVENTION

The present invention relates to the field of electrical generators, and more specifically, it relates to a generator having a novel orientation of magnets wherein the full magnetic field is made available to induce current which travels through the windings of the stator and a vented stator design which allows the dissipation of heat from the structure.

### BACKGROUND OF THE INVENTION

Electric generators are devices that are used to convert mechanical energy into electrical energy. “Electromagnetic induction,” discovered in 1831 by Michael Faraday, is the production of electric current in a circuit when it is passed through a changing magnetic field, and is the force or impetus that enables electric generators to function. Typically, conventional generators use the movement of magnetic fields to produce current in a conductor that is placed in the magnetic fields. The prior art designs employ the standard bipolar magnetic field on the rotors and utilizes windings that are entirely embedded in stators of metal and/or resins. The continuous use of generator comprising conventional designs, however, leads to the buildup of heat within the structure overall, causing all of the components of the generator to become heated (and in some instances over-heated), which promotes wear and tear of the components. In addition to contributing to wear on the various generator parts, the heat generated also constitutes lost energy and, as such, directly contributes to reduction in efficiency. The bipolar magnetic field typically used in the prior art inherently produces circumstances wherein the lines of flux flow between the north and south poles of magnets that are oriented in such a manner that only a portion of the magnetic field intersects the physical space occupied by the current carrying conductors.

Accordingly, there is a need to develop an electrical generator that will efficiently produce a large amount of electricity at a low cost and address the issues of loss of energy in the form of escaped heat as well as maximizing the use of the magnetic flux produced. The present invention is designed to address these needs in a cost efficient, straightforward manner.

### SUMMARY OF THE PRIOR ART

In the prior art, Applicant is aware of U.S. Pat. No. 7,081,696 which teaches a ‘polyphasic multi-coil generator.’ The prior art includes circular stators and rotors arranged in a ‘sandwich’ pattern on the shaft of the generator. The rotors each have an array of magnets spaces on the rotor, and the rotors are position in such a manner that at least one stator is sandwiched between rotors. In sum, the '696 patent teaches utilizing a stator sandwiched between rotors containing fixed permanent magnets, and the stators are “interleaved” with the rotors. The rotors are physically interposed in the same space as the stators unlike the present design wherein the rotors sit adjacent to but outside of the stators.

Applicant also is aware of U.S. Pat. No. 7,298,063 which teaches a generator design utilizing multiple disc shaped permanent magnet polefaces which serve as the stators in the design and armatures which serve as the rotors in the design, where the output current is generated in windings located on the armatures. It is therefore the rotating mechanical portion wherein the output current is generated, as opposed to in the current invention wherein the output power is generated in windings located in the stationary portion of the generator. Because the output current is generated in the rotating part of the design, the prior art utilizes brushes to transmit generated current from the windings in the rotors out of the generator to the load. The present invention does not utilize any brushes since the current is generated in the stationary portion of Applicant's generator.

In addition, Applicant is aware of U.S. Pat. No. 7,309,938 which teaches a generator design that, as the other patents noted above, utilizes ‘ganged’ rotors and stators in a single generator set. The rotor-stator assemblies in this invention, however, are standard (older) designs that have the rotors positioned inside of the space created by doughnut-shaped stators.

Applicant also is aware of is U.S. Patent Application Publication No. US 2008/0179982, which teaches a transverse flux switched reluctance traction motor that essentially is an electric drive for a wheel of a vehicle. It describes, in part, parallel rotors and stators that provide electric drive force for wheels.

While those patents noted above and the '982 application show a ‘ganged’ rotor setup, none of these designs, however, provide a means for cooling and ventilating the generator system to withdraw heat created during use, nor does any design in the prior art make use of a unipolar magnet design, or of any other design for that matter, to create a means by which permanent magnets are oriented in a manner to incorporate a physical unipolar magnet format so as to render the entire magnetic field available to induce current which travels through the windings of the stator, as opposed to the standard bipolar magnetic field across each rotor, thereby increasing efficiency.

### SUMMARY OF THE PRESENT INVENTION

It will be understood by those skilled in the art that alternating electrical current is generated in electrically conducting materials by passing magnetic fields through windings of the electrically conducting materials as the magnetic sources and the electrically conducting materials are moved relative to one another.

In summary, the present ‘ganged’ electrical generator comprises the following: (1) a generator design with mechanical input into a rotor shaft; (2) one or more stators; (3) two or more rotors, the rotors being affixed to the rotor shaft, located parallel to the stator(s), and comprised of non-ferrous materials, and to which a plurality permanent magnets are affixed in a unipolar fashion; and (4) a design wherein the rotors and stator(s) are placed such that each stator has the magnetic fields of at least two rotors interacting with the windings of that stator.

The rotors of the present invention are constructed of non-conducting and non-metallic materials. These materials can include but are not limited to plastics and other artificial substrates, as well as natural substrates with the same characteristics.

Within the rotors, circular openings located throughout the rotor provide airflow and cooling, while at the same time reducing the amount of material required to construct each rotor, thereby reducing costs as well as overall weight of both the rotors and the generator as a whole.

In one embodiment of the present invention, the rotors are of a ‘sandwich’ design wherein two halves of a rotor are formed separately, and then joined with the plurality of permanent magnets sandwiched between the two layers. The two opposing rotor halves may be affixed to each other permanently, or may be affixed by screws or the like. In this manner, the rotor is easily dissembled for repair and/or replacement of any component parts, including the repair and/or replacement of any or all of the plurality of permanent magnets.

In operation, each set of two (2) rotors have a stator positioned in between them such that the rotors rotate about the generator shaft in a plane parallel to the plane of the stator that is perpendicular to the shaft. At the end position of the ‘ganged’ rotors and stators are positioned rotors so that no stator remains without a magnetic flux flowing through it from one rotor to another.

The plurality of permanent magnets are oriented such that, rather than the magnets having opposing poles (north (N) and south (S)) located at opposite ends of a magnet in a plane parallel to the rotor and perpendicular to the shaft. The N/S orientation of each magnet positioned in a rotor is alternated vertically with relation to the shaft such that the poles of magnets opposite each other on two separate rotors are comprised of opposite poles and the entirety of the magnetic flux field between the N and S poles of the separated magnets flows through the stator and the windings located within the stator.

When the ganged generator of the present invention utilizes the present invention's permanent magnet orientation in conjunction with the ‘ganged’ design disclosed herein, a continuous unbroken magnetic field runs through each rotor and each stator in a line parallel to the shaft. As the shaft is rotated, each winding in the stator feels a magnetic field flux in one direction parallel to the shaft, and the subsequent set of permanent magnets in rotation on the rotor present the magnetic field flux flowing in the opposite direction, giving rise to an alternating current within the windings. Each winding therefore ‘experiences’ a magnetic flux similar to the effect that would be obtained if unipolar permanent magnets were installed on either side of the rotor. Further, the overall strength and effect of the large, continuous magnetic flux is greater than the overall strength and effect of the individual magnetic fluxes utilized by current generator designs. The present invention increases the overall efficiency of an alternating generator.

The overall design of the windings incorporates isolated ‘doughnut’ shaped windings that rest in hollow areas contained between two ‘sandwiched’ halves of a stator assembly. This configuration provides several advantages, including the advantage that a stator assembly may be disassembled and individual windings may be replaced without the material cost and time expense of replacing an entire stator assembly.

In a preferred embodiment, the present invention incorporates nine (9) coils of windings per stator and twelve (12) permanent magnets per rotor, although any number of coils and windings may be used. Because the magnetic flux created by the magnets on opposing rotors flows through the windings, the windings ‘see’ a single magnet created by the two opposing magnets. The most efficient design, however, and a preferred embodiment maintains a ration of 3:4 windings to magnets.

It is an object of this invention to provide a means of creating a unipolar-like magnetic field whereby the magnetic lines of flux produced are cut and wholly go through windings of the stator.

It is a further object of the present invention to provide a novel generator rotor design.

It is a further object of the present invention to provide a novel generator configuration that is more efficient at capturing magnetic flux energy than current designs.

It is a further object of the present invention to provide a novel generator configuration that is more efficient at dissipating heat than current designs.

It is another object of this invention to provide ventilated stators that enable an efficient and effective means of dissipating the heat that is created during use of the generator system.

It is yet a further object of the present invention to provide a ganged generator that provides for the easy repair and/or replacement of individual component parts, including the windings and the permanent magnets.

### BRIEF DESCRIPTION OF THE DRAWINGS

In the accompanying drawings:

FIG. 1 is a simplified cross sectional perspective view of the present invention showing a shaft and alternating rotors and stators, wherein each stator is positioned between a pair of rotors;

FIG. 2 is a cross sectional perspective view of a prior art stator, showing a plurality of coils within the stator, magnets that are aligned with their respective north-south axis perpendicular to the linear axis of the shaft, and the resulting magnetic flux;

FIG. 3 is a cross sectional perspective view of the present invention, showing a single representative magnet within each rotor having the north-south axis of each magnet parallel to the linear axis of the shaft;

FIG. 4a is a cross sectional perspective view of the interior construction of a first half of a stator as utilized in the present invention;

FIG. 4b is a cross sectional perspective view of the exterior construction of the second half of a stator as utilized in the present invention;

FIG. 5a is a cross sectional perspective view of the construction of the first half of a rotor as utilized in the present invention; and

FIG. 5b is a cross sectional perspective view of the construction of the second half of a rotor as utilized in the present invention.

### DESCRIPTION OF THE PRESENT INVENTION

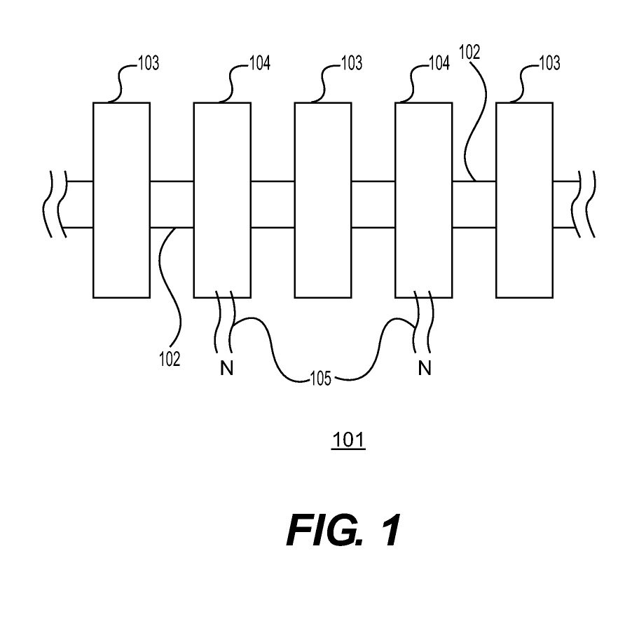

Referring now to FIG. 1, an embodiment of the present invention is shown as a ganged generator 101, with a shaft 102, rotors 103 and stators 104.

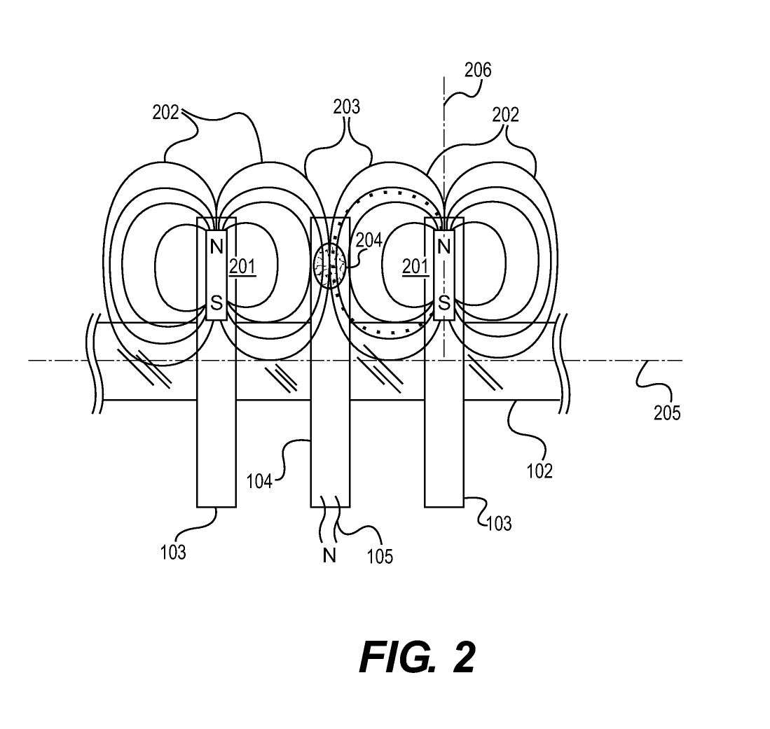

Referring now to FIG. 2, an embodiment of a stator 104 showing the prior art in the field with a pair of rotors 103 is shown with the magnetic flux 202 from a magnet 201 located within each of the rotors 103. Located within the stator 105 is a plurality of coils 204. The coils 204 are positioned such that the magnetic flux 202 induces a current in the coils 204 as the rotors 103 rotate around the shaft 102. This embodiment shows the current state of the art wherein the magnetic flux 202 originates and returns to the same magnet 201, and the magnets 201 are oriented with the north-south axis 206 of the magnets 201 is perpendicular to the linear axis 205 of the shaft 102. This has the effect, as shown, of only exposing the coils 204 to a portion of the magnetic flux 202, thereby reducing the efficiency of the generator. The generation of an electrical current by rotating magnetic fields through stationary conductors is well known in the art, although the current invention teaches a unique and more efficient configuration of a generator.

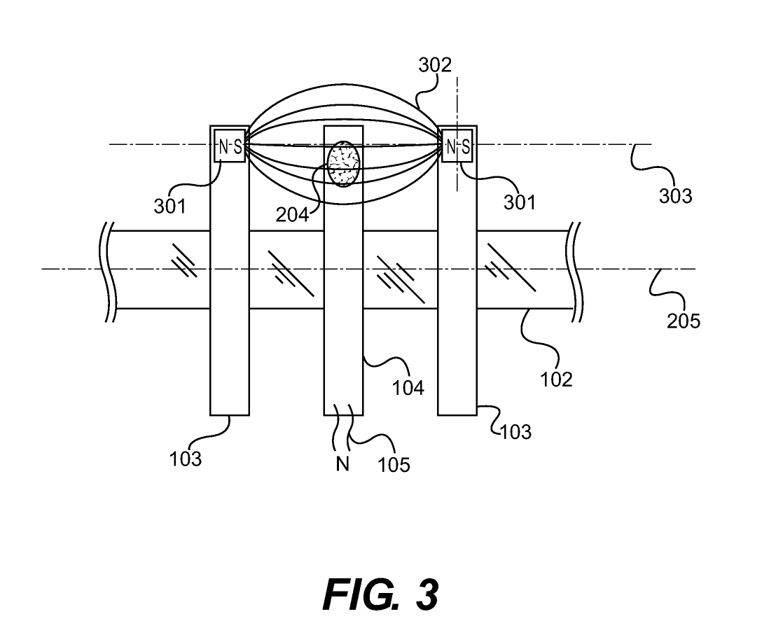

The present invention, in a preferred embodiment as shown in FIG. 3, comprises a plurality of magnets 301 within each rotor 103 that are oriented such that the north-south axis 303 of each magnet 301 is parallel to the linear axis 205 of the shaft 102. The orientation of the magnets 301 is such that, as shown in FIG. 3, the magnetic flux 302 originates in one magnet 301 and ends in another magnet 301 contained within a rotor 103 separate from the originating magnet 301 rotor 103, and opposite the stator 104 containing the magnets 204 within which the electric current is generated. While FIG. 3 shows a single representative magnet 301 in each rotor 103, it will be understood that the present invention is intended to comprise a plurality of magnets 301 within each rotor 103. In another preferred embodiment the ratio of magnets 201 in each rotor 103 to the coils 204 is 4 to 3, such that for each 4 magnets 201 there are 3 coils 204.

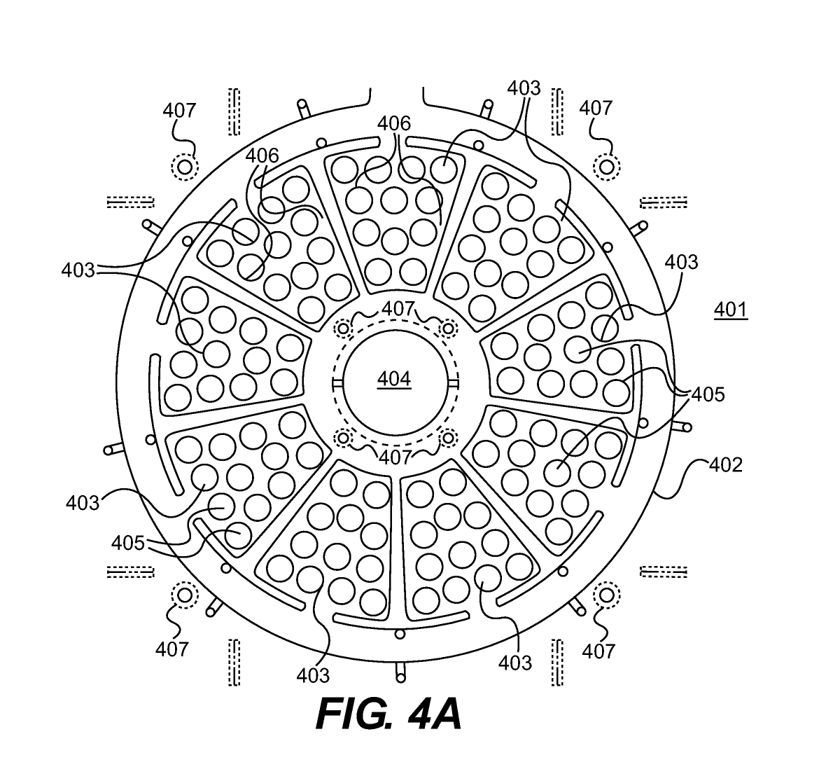

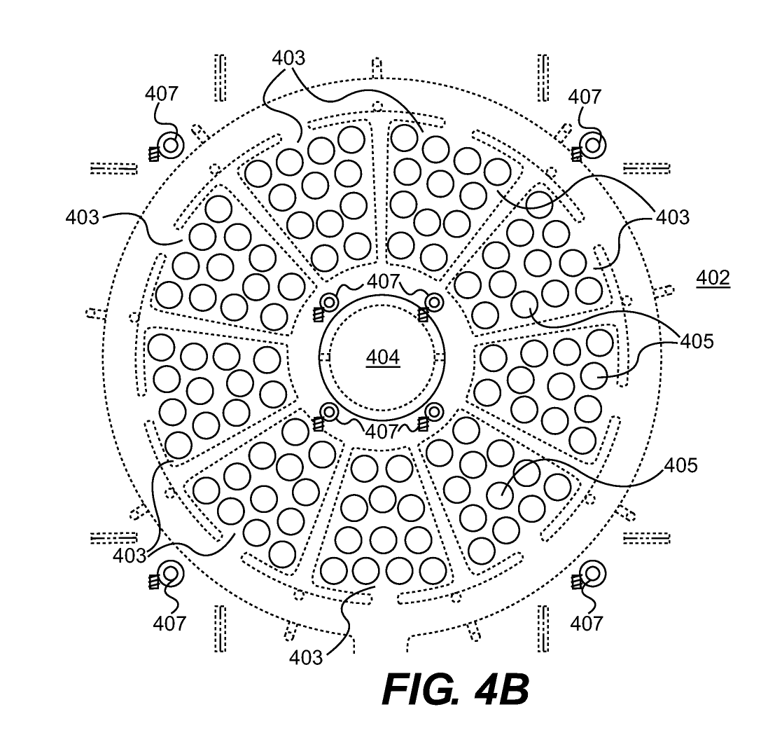

Referring now to FIG. 4a and FIG. 4b, a view of the interior construction of a first half 401 and a second half 402 of a stator 104 in accordance with an embodiment of the present invention is shown in FIG. 4a and an exterior view of a second half 402 is shown in FIG. 4b. The said first half 401 and second half 402 comprise duplicate designs and construction in a preferred embodiment, such that all references to the portions of the first half 401 correspond to the portions of the said second half 402 as well. The first half 401 comprises a circular outer circumference 402 with a plurality of recesses 403. The plurality of recesses 403 are of a predetermined depth to hold coils 204. While it will be understood that the plurality of recesses 403 may comprise any number to accommodate a desired number of coils 204 to generate a desired electrical current, in a preferred embodiment of the present invention the plurality of recesses 403 and the coils 204 are nine each, such that each recess 403 houses one coil 204. The coils 204 remain contained within the recesses 403 between the first half 401 and the second half 402 such that, if the first half 401 and the second half 402 are separated, each of the coils 204 may be removed for repair and/or replacement. It will be further understood that the plurality of recesses 403 may comprise any shape so as to retain the coils 204. In a preferred embodiment, the plurality of recesses 403 are generally polygonal with sides 406 that radiate linearly from the center point of the shaft opening 404. The preferred shape of the recesses 403 is the generally polygonal shape as shown in FIG. 4a, although it will be understood that the recesses 403 may be of any desired shape that will accommodate the coils 204. The shape of the recesses 403 shown in FIG. 4a is a preferred shape that provides an efficient shape to retain a coil 204 as well as reducing the amount of solid material utilized to construct the stator 104. Holes 406 are cut into the first half 401 and the second half 402, the holes preferably round. While the present invention may be constructed without the holes 406, in a preferred embodiment the holes 406 are provided to assist with cooling and to reduce the amount of material necessary to construct the rotor 104.

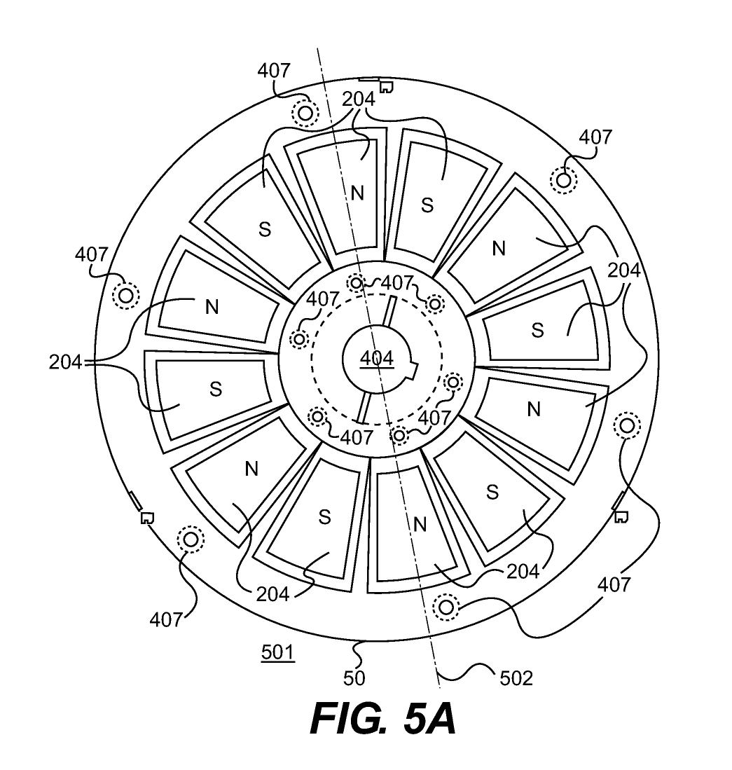

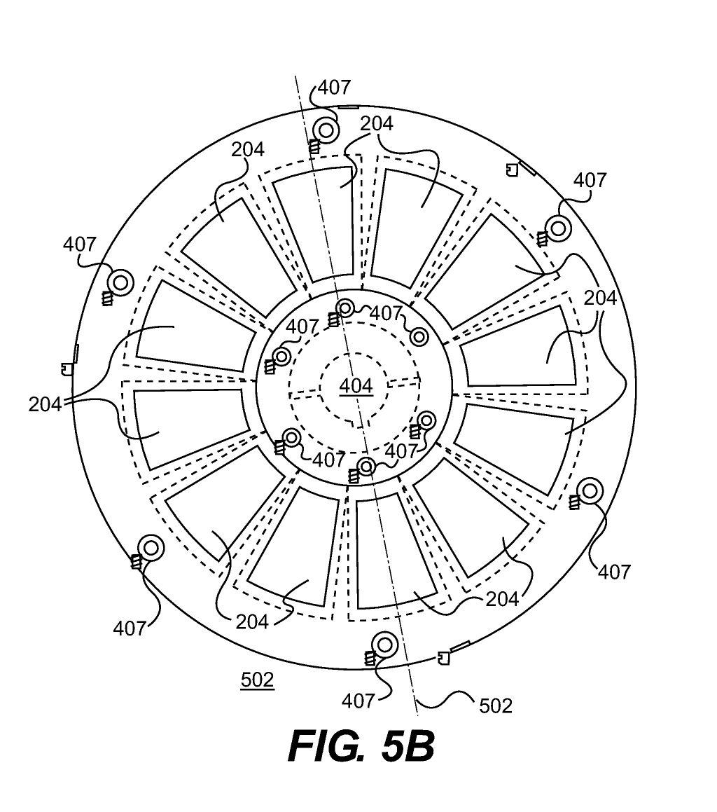

The first half 401 and the second half 402 are connected together utilizing connecting means 407, with the coils 104 positioned in the plurality of recesses 403 and contained between the first half 401 and the second half 402. Connecting means 407 are well known in the art, and any connecting means 407 that affixes the first half 401 and the second half 402 while permitting the connecting means 407 to be undone such that the first half 401 and the second half 402 may be separated as desired. The rotors 103 are constructed in a similar manner with connecting means 407 allowing a first half 501 (FIG. 5a) of a rotor 103 to be connected to a second half (FIG. 5b) such that the connecting means 407 may be undone and allow the first half 501 to be separated from the second half 502.

Referring now to FIG. 5a and FIG. 5b, a first half 501 and a second half 502 of a rotor 103 is shown. The plurality of magnets 204 are oriented along the axis 502 such that, when viewed as shown in FIG. 5a, each magnet 204 presents a single pole, alternating north-south around the circumference of the rotor 103. As shown in FIG. 3, this orientation of the magnets 204 presents a magnetic field 302 that is parallel to the linear axis 205 of the shaft 102 such that the entirety of the magnetic field 302 flows through the rotors 103. As the rotors 103 and the stators 104 are “ganged” along the shaft 102, the orientation of the magnets 204 presents a continuous linear magnetic field 302 along the linear length of the apparatus. The interaction between the alternating north and south poles of the magnets 204 located within the same rotor 103 is therefore minimized, while the interaction between the north and south poles of rotors 103 located on opposite sides of the stators 104 is enhanced.

It will be understood by those skilled in the art that, although the present invention is described herein in a preferred embodiment, there are modifications and alterations that may be made that, although not specifically disclosed herein, constitute changes that do not fall outside of the scope of the present invention.

What is claimed is:

1. A device for generating electrical power.

2. The device of claim 1 wherein said device for generating electrical power comprises one or more stators and one or more rotors, the stators and rotors aligned along a shaft that is rotationally mounted such that the shaft may rotate about a linear axis running lengthwise through the center of the shaft, the stators fixedly mounted to the device such that the stators do not rotate, and the rotors fixedly mounted to the shaft such that the rotors rotate about the linear axis as the shaft is rotated.

3. The device of claim 2 wherein the said one or more stators comprise two halves fixedly joined together, and forming a plurality of hollow portions within each of the one or more stators.

4. The device of claim 3 wherein one or more windings of electrically-conducting material are positioned within the plurality of hollow portions with each of the one or more stators.

5. The device of claim 2 wherein the said one or more stators comprise two halves fixedly joined together, and forming a plurality of hollow portions within each of the one or more rotors.

6. The device of claim 5 wherein one or more magnets are positioned with the plurality of hollow portions within each of the one or more rotors.

7. The device of claim 6 wherein the said one or more magnets are positioned such that the north-south field of the said one or more magnets is oriented parallel to the horizontal axis of the shaft.

8. The device of claim 2 wherein the said one or more stators and said one or more rotors further comprise empty circular portions cut into and through the said rotors and said stators.

9. The device of claim 2 wherein said one or more stators and said one or more rotors comprise modular portions that are individually repairable or replaceable.

10. The device of claim 2 wherein each one or more said stators are positioned between a plurality of rotors wherein each stator has at least one rotor positioned on each side of each one or more stators.

11. The device of claim 2 wherein said device comprises means for providing a plurality of continuous magnetic fields oriented parallel to the linear axis of the shaft of the said device.

12. A device for generating electrical current, said device comprising one or more stators, two or more rotors, the one or more stators sandwiched between the said two or more rotors, and said rotors providing magnetic means for creating a plurality of continuous magnetic fields located parallel to the axis of the shaft about which the said rotors rotate, the said continuous magnetic fields being rotated with respect to the shaft such that magnetic lines of flux generate electric current within windings located with the said one or more stators.

13. The device of claim 12, wherein said one or more stators and said two or more rotors consist of modular parts.

14. The device of claim 12 wherein said magnetic means comprises a plurality of magnets oriented with the north-south axis of the magnets parallel to the linear axis of the shaft about which said rotors rotate.

15. Means for generating electricity, said means comprising the steps of positioning one or more stators containing electrically conducting windings between two or more rotors containing a plurality of magnets which create magnetic fields, the two or more rotors mechanically attached to a shaft about which the rotors are rotated, causing the magnetic fields to intersect the electrically conducting windings, and the magnetic fields being oriented parallel to the linear axis of the shaft about which the rotors are rotated, and further containing means for conducting the electrical current generated in the electrically conducting windings to a desired electrical load.
